(19) United States
(12) Patent Application Publication
(10) Pub. No.: US 2011/0087558 A1
(43) Pub. Date: Apr. 14, 2011

(54) INFORMATION EXCHANGE SYSTEM

(75) Inventors: Chris Kalaboukis, San Jose, CA (US); Carrie Burgener, Mountain View, CA (US); Rahul Nair, Sunnyvale, CA (US); Simon P. King, Berkeley, CA (US); Ron Martinez, San Francisco, CA (US); Marc Eliot Davis, San Francisco, CA (US); Chris W. Higgins, Portland, OR (US); Duane R. Valz, Emeryville, CA (US)

(73) Assignee: Yahoo! Inc., Sunnyvale, CA (US)

(21) Appl. No.: 12/577,555

(22) Filed: Oct. 12, 2009

(51) Int. Cl. G06Q 30/00; G06F 17/30; G06F 7/10; G06Q 99/00; G06Q 20/00

(52) U.S. Cl. 705/26.64; 707/E17.108; 705/39; 705/1.1

(57) ABSTRACT

A method for operating an electronic exchange includes receiving, at an exchange system, an offer that includes a description of information for offer and terms associated with access to the information. An offer processor of the electronic exchange stores an offer listing associated with the offer to an offer database. A matching engine of the electronic exchange searches a request database for a request listing that matches the offer listing. The electronic exchange communicates access instructions that enable access to the information to a requestor associated with the request listing when a match is found.

### BACKGROUND

The Internet has emerged as a powerful tool for gathering, producing and processing data as well as communicating information. For example, many search engines exist that enable individuals to search for information on various web sites and each individual creates their own data by their actions, observations and transactions. This data may indicate preferences about their interests, activities and commercial behaviors. Some web sites are front ends to vast amount of encyclopedia information available at other sources, while some web sites are the exclusive source for certain information. Many of these web sites are funded through advertising that is targeted towards members of the audience that visit the web site. Advertisers typically enter into a competitive bidding process to procure space on such web sites and/or access to such users.

However, there are limits to the types of information that may be found on the Internet. Oftentimes, searchers spend countless hours or days in a futile attempt to locate a piece of information. While at the same time, others may possess the information sought and may be willing to share the information with others, but have no means for letting others know that they have the information. In still other cases, searchers may be interested in the insight gained from processing data yet not be interested in the data itself and have no means to contract for the insight from a validated and trusted source.

### BRIEF DESCRIPTION OF THE DRAWINGS

FIG. 1 illustrates an exemplary exchange system in communication with a requestor and a first and a second offeror;

FIG. 2 is one implementation of the exchange system of FIG. 1;

FIG. 3 illustrates an exemplary table of request listings that may be stored in a request-listing database of the exchange system;

FIG. 4 illustrates an exemplary table of offer listings that may be stored in an offer-listing database of the exchange system;

FIG. 5 illustrates exemplary operations performed by the exchange system in processing an offer;

FIG. 6 illustrates exemplary operations performed by the exchange system in processing a request; and

FIG. 7 illustrates a general computer system, which may represent any of the computing devices referenced herein.

### DETAILED DESCRIPTION

The embodiments below describe one implementation of an exchange system that enables the exchange of information between one or more offerors and one or more requestors. As used herein, an offeror is an individual or entity with information that the offeror is willing to share. A requestor is an individual or entity that is searching for information. The exchange system provides an interface that enables an offeror to post a description of the information for offer along with terms and other information for sharing the information as well as for a requestor to post a description of the information sought along with terms and other information for sharing the information when a satisfying source or resource is not immediately available matching the request.

The exchange system also provides an interface that enables a requestor to request and/or search for information that may be provided by offerors and/or available through existing resources such as publically accessible online databases. The exchange system may be configured to communicate information identifying matched offerors and/or sources of information to the requestor and to interactively process the agreement of compensation or other terms among the parties.

In some implementations, the information sought is communicated directly to the requestor by the exchange system. In other implementations, a requestor works with an offeror to have the information communicated by for example a link or access code or application configured to provide access under the terms.

When no offers match the request, a request description may be added to a database of request listings and may be matched with an offer later and/or be interactively discovered by offerors through a search, browse and discover user interface.

In some implementations, the exchange system enables the transfer of information between members of a cooperative and others. As used herein, a cooperative is a group of individuals registered with the system that are associated in some way. For example, the individuals may be a cooperative of lawyers. Members of the cooperative may be requestors and/or offerors and may restrict the sharing of information to between themselves in aggregate or in specific delimited subjects, circumstances or means. In some implementations, the cooperative itself may be an offeror willing to share generalized information about members of the group while maintaining the anonymity of the individual group members. Cooperatives may be defined by a finite set of specific users, e.g. woman over 25 in the 981001 zip code with annual income over $100K or may also be defined an unbounded set of users defined by an permanent or transient attribute, e.g. Middle School parents or visitors of Mount Rushmore. This enables providing information about a group of individuals without compromising the privacy of the individual group members, or in order to maximize the return for any agreed upon personal disclosures. Revenue collected for sharing the information may be distributed among the members of the cooperative or reapplied to further discover and market the value of the cooperative's information or data feeds.

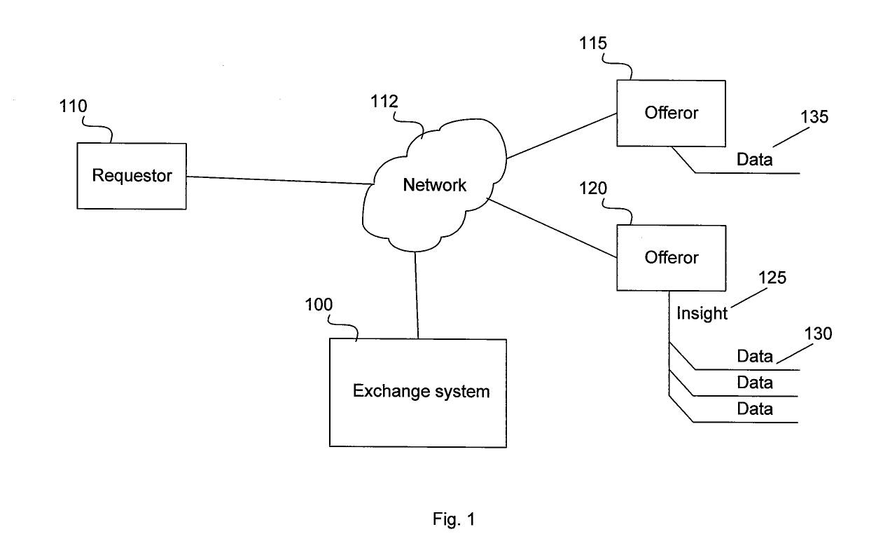

FIG. 1 illustrates an exemplary exchange system 100 in communication with a requestor 110, a first offeror 115, and a second offeror 120 via a network 112 such as the Internet. The requestor 110 and offerors 115, 120 are intended to be exemplary only. The exchange system 100 may operate in conjunction with any number of such participants. As noted above, offerors may be individuals or entities with access to information that they are willing to share. The information can be any type of information. For example, the information may be raw data, insight information, statistical information, demographic information, or any other type of information that an individual may have access to and is willing to share.

Raw data is generally unprocessed information. Raw data may come from a variety of “sensor” sources. For example, the raw data may come from a spreadsheet, a report or a different document. Sensor raw data may come from any number of other sources including an application, an environmental sensor, a biometric sensor or implant, a device, a vehicle, any appliance, vendor, data source or interconnected network. For example, a first offeror 115 may have access to a sensor such as a weather-monitoring station attached to a home. The first offeror 115 may then share data produced by the sensor with others according to terms. Data may be shared in batches, values or as a live continuous feed.

As used herein, insight information includes raw data that has been processed in some way. The processing may have been performed by a person, a cooperative and/or a machine. Patterns within the information may provide one with certain sharable insights. An insight may be more valuable than the underlining raw data because the insight represents processed information. In other words, a recipient of the insight information may benefit from the processing performed by the person and/or the machine with access to the raw data, and in turn may rely on the processor of the data for the integrity of the insights being offered. For example, a second offeror 120 may have access to raw data 130 from a variety of sources such as automobile sales records from several car dealerships in a major metropolitan market. The second offeror 120 may process and/or analyze the data to gain additional information or insight information. For example, analyzing the raw data may give the second offeror 120 an insight into automobile shopping habits by age or some other attribute in the metropolitan market. By analyzing the raw data and offering the analysis to others, the second offeror 120 adds or creates value beyond the value of the unprocessed data. This insight information may then be shared with others via the exchange system 100 according to terms provided by the second offeror 120.

In some implementations, offerors communicate a description of the available information to the exchange system 100. The offeror may also communicate terms for sharing the information, such as monetary, non-monetary, points, miles, reputation score, quality score, attribution rights, linking rights, information access rights or other terms. For example, the agreed compensation may specify a money amount to be transferred from the requestor's account to the offeror's account in exchange for receiving the information or on a regular basis while access continues. The structure of the terms may be dictated by the offeror or negotiated automatically or interactively among one or more requestors and offerors. For example, an offeror willing to share sensor data may specify a one-time access charge or a daily, weekly, or monthly access charge for sharing information generated by a sensor, but the same offeror may be willing to exchange the data for free for an in-kind information where the exchange of value is in the data shared and not any monetary exchange. The frequency of the information or data deliveries can be anything agreed upon from one-time to ongoing and continuous. In some instances, when a match is found, the exchange is automated because the terms are within the automated instructions provided by all parties, while in other instances, the requestor and the offeror may negotiate fully customized and mutually beneficial terms.

In addition to monetary terms, an offeror may specify other terms, such as access rights to the information. For example, an offeror may not be willing to share information with his competitors, while a different offeror may only want to share information with a non-profit organization. The offeror may communicate these terms or other terms to the exchange system 100 or may add them depending on the actual identity of the requesting party.

As noted above, the requestor 110 is an individual or entity searching for information. The exchange system 100 provides an interface that enables a requestor 110 to specify the type of information sought. In some implementations, the requestor 110 is able to specify the information sought using keywords or in plain text. For example, the requestor 110 can specify the following request: “Looking for classmate that graduated from Main high school in 1985” or “Contact information for John Smith, Main High School Class of 1985.” In other instances, an intake categorization system like a directory enables requestors to describe and label their requests.

The exchange system 100 may enable the requestor 110 to filter potential offers. For example, the exchange system may enable filtering potential offers based on the terms of the offer, based on the source or resource and/or the identity of the offeror. Other suitable filtering techniques may be utilized.

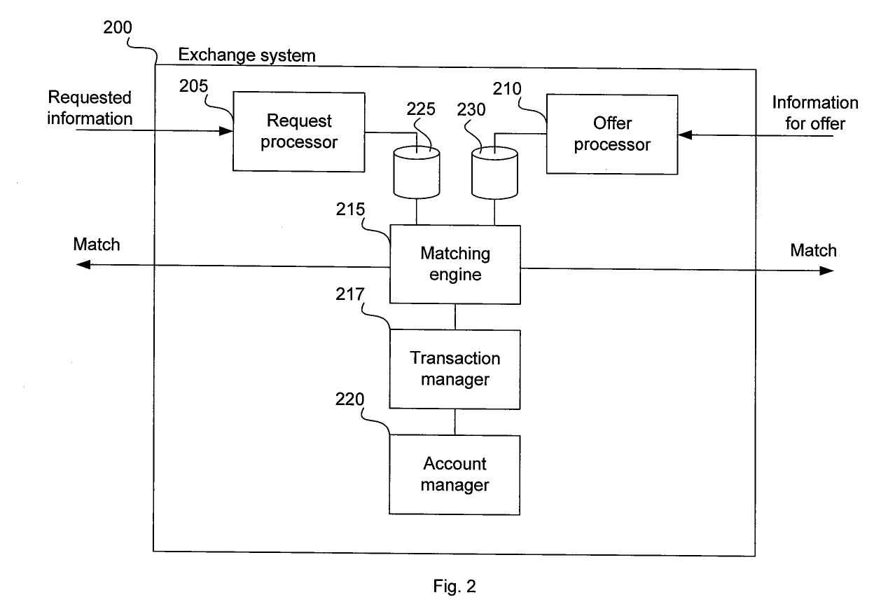

FIG. 2 is one implementation of an exchange system 200 that may correspond to the exchange system 100 of FIG. 1. The exchange system 200 includes a request processor 205, an offer processor 210, a request-listing database 225, an offer-listing database 230, a matching engine 215, a transaction manager 217, and an account manager 220.

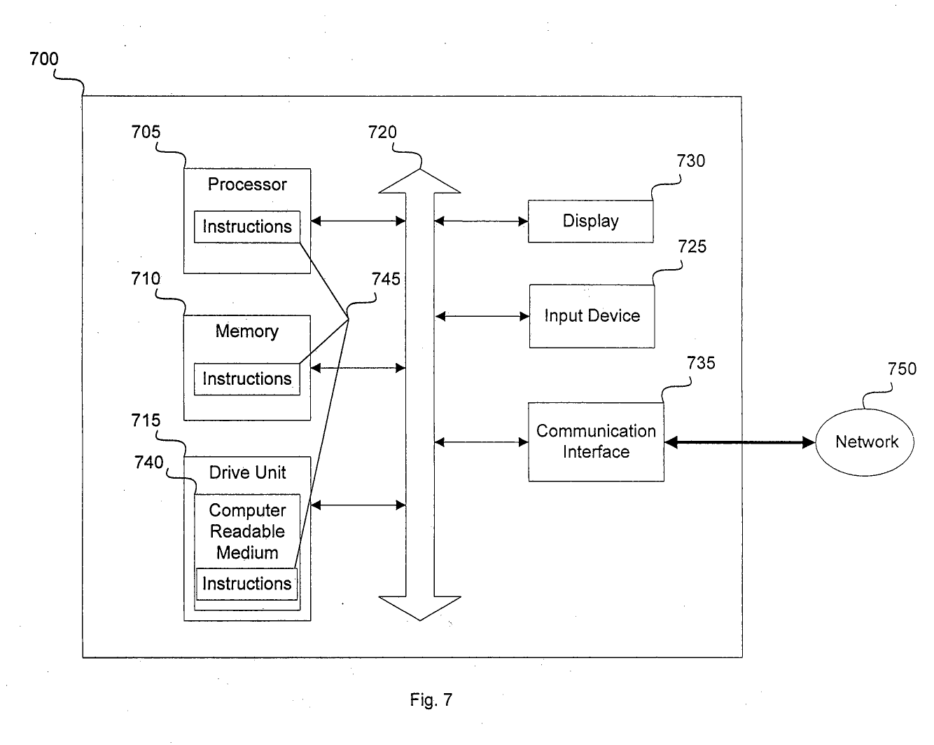

The request processor 205, offer processor 210, request-listing database 225, offer-listing database 230, matching engine 215, transaction manager 217, and account manager 220 may be implemented in one computer system or a number of computer systems deployed in a networked environment. The computer systems may correspond to any generalized computing device, such as an Intel®, AMD®, and/or PowerPC® based computer running an operating system, such as a Microsoft Windows®, Linux®, and/or Unix® operating system. The computer systems may be adapted to communicate with another computer system via an interface such as a network interface. The computer systems may include the various subsystems shown in FIG. 7, which is described below.

The request processor 205 may be adapted to communicate information with a requestor via an interface such as a webpage (not shown). The interface may enable specifying registration information. For example, fields for specifying a user name and password associated with a requestor may be provided. Fields may also be provided for specifying whether the requestor is an individual, a corporation, a member of a cooperative, or a different organization. Other fields may be provided for specifying a requestor's addresses and bank account information as well as defining existing data feed or information exchange relationships. Fields for specifying other information may be provided. Any suitable technique for conveying information, such as a hypertext markup language web page, a data file, streaming data or any other apparatus or method may be used.

The interface also enables specifying request information. For example, a request description corresponding to the information sought by the requestor may be specified including the type and expiration of the request. Other information, such as what the requestor is willing to offer for the information, may also be specified. The registration information and the request information may be stored in a database, such as the request-listing database 225. Alternatively, the registration information and the request information may be stored in a number of databases and be interactively available for discovery to information sources or information resource owners.

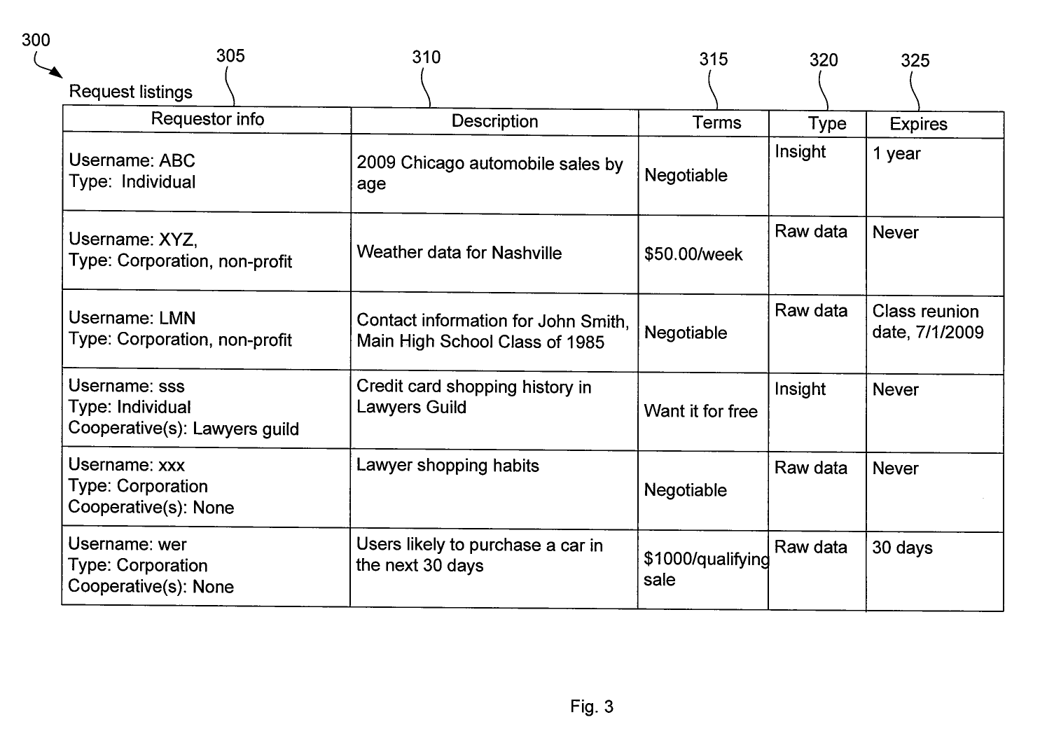

FIG. 3 illustrates an exemplary table of request listings 300 that may be stored in the request-listing database 225 (FIG. 1). The table 300 includes a requestor information column 305, a description column 310, a terms column 315, a type column 320, and an expiration column 325. The requestor information column 305 provides information about the requestor associated with a given request listing. For example, the user name of the requestor may be specified. The type of requestor, such whether the requestor is an individual, corporation, and/or cooperative, may also be specified. Where the requestor is a corporation, other information, such as whether the corporation is non-profit, may be specified. Where the requestor is part of a cooperative, the name of the cooperative may be specified. Other information about the requestor may also be specified in the requestor information column 305.

The description column 310 describes the information that the requestor is searching for. As noted above, the description may be specified in key words. For example, “lawyer shopping habits” may be specified. A plain text description such as “looking for classmate that graduated from Main high school in 1985” may also be specified. This provides the requestor maximum flexibility in describing information sought. Additionally, the description may include the name or user name associated with an offeror. This may enable direct routing of the request to a specific offeror, which is described in more detail below.

The terms column 315 provides information about what the requestor is willing to exchange for the information. For example, the requester may want to specify a maximum money amount to be paid for a given piece of information. In some implementations, the maximum money amount is not revealed to offerors. Rather, the maximum money amount may be utilized to filter potential offers. For example, only offers that are below or equal to the maximum money amount may be matched to the request listing and shown to the requestor.

In some implementations, the maximum money amount may be utilized in a competitive bidding process. For example, the maximum money may be utilized to set a maximum bid amount where an offeror is auctioning the information to the highest bidder.

In addition to monetary values, the terms column 315 may specify that the requestor is willing to negotiate terms with the offeror. Alternatively, the terms column 315 may specify information, attribution or an item for trade. For example, an object that the requestor is willing trade for the information, such as a motorcycle, may be specified. The requestor may also offer information for trade. The requestor can essentially offer anything that can be exchanged including but not limited to cash, credit, points, miles, reputation certification or quality scoring, attribution rights, linking rights and/or access rights.

The type column 320 indicates whether the type of information sought, such as raw data or insight information. That is, data that has been processed in some way to reveal insights embedded in the data. For example, the insight “users likely to purchase a car in the next thirty days” is based upon complex processing applied by the offeror to the raw data and the terms reflect this because the offeror is only requiring compensation if the user actually buys a car.

The expiration column specifies the conditions under which the request for information will expire. For example, an amount of time, such as hours, days, weeks or any other measure of time, may be specified as well as a perpetual offer without any expiration. A date or date range for when the request will be valid may be specified. Other conditions may be specified.

Returning to FIG. 2, the offer processor 210 may be adapted to communicate information to and from an offeror via an interface such a webpage (not shown). The webpage may enable entering a description of the information that the offeror is willing to share. The webpage may also enable communicating the actual information and terms associated with the sharing of the information. Registration information, such as the offeror's address, bank account information, and any other information that may characterize the offeror, such as whether the requestor is working on behalf of an organization or social purpose, may also be communicated. The description information and registration information may be stored in the offer-listing database 230 or distributed across a number of databases.

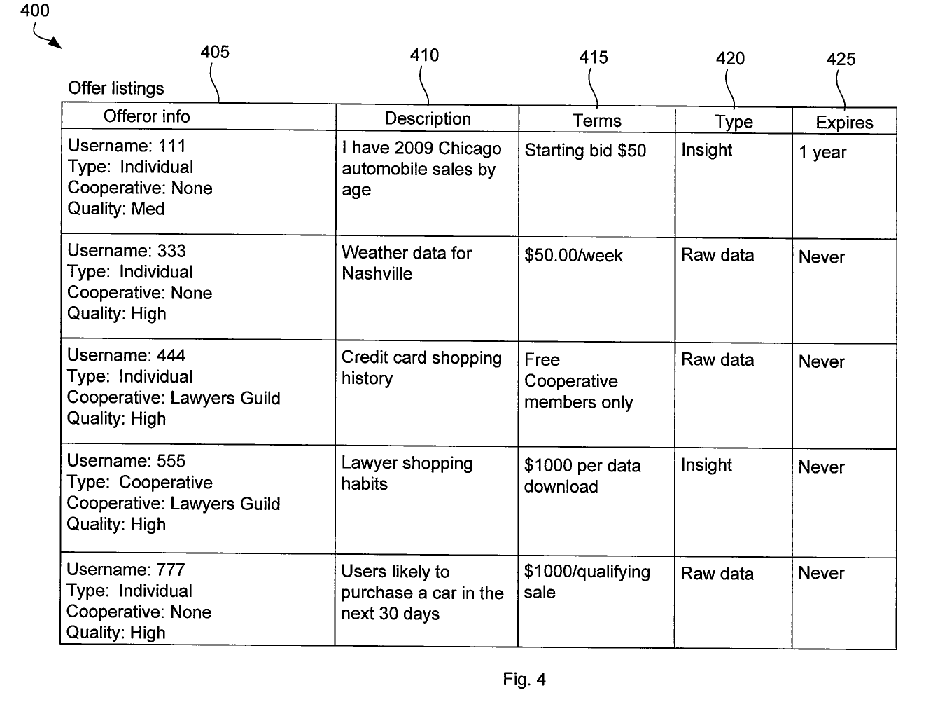

FIG. 4 illustrates an exemplary table of offer listings 400 that may be stored in the offer-listing database 230 (FIG. 2). The table 400 includes an offeror information column 405, a description column 410, terms column 415, type column 420, and an offer expiration column 425. The offeror information column 405 provides information about the offeror associated with an offer listing. For example, the user name of the offeror may be specified. The type of offeror, such as whether the requestor is an individual, corporation, and/or cooperative, may also be specified. Where the offeror is a corporation, other information, such as whether the corporation is non-profit, may also be specified. Where the offeror is part of a cooperative, the name of the cooperative may be specified. Other information about the offeror may also be specified in the offeror information column 405.

The description column 410 describes the information the offeror is willing to share. As noted above, the description may be specified in key words, tags, attributes or directory or database addresses. For example, “lawyer shopping habits” may be specified. A plain text description may also be specified. For example, “I have 2009 Chicago automobile sales by age.” This provides the offeror maximum flexibility in describing the information the offeror is willing to share.

The terms column 415 provides information about the terms associated with an offer listing. The terms may be monetary. For example, an offeror may offer data about the weather of Nashville, Tennessee, for $50 per week. The terms may correspond to a starting bid where the offeror is auctioning the information. The terms may specify limits on who may receive the offer. For example, the terms may limit the offer to members of a cooperative. The terms may call for an information exchange. The terms may also be negotiable or may specify other requirements.

The type column 420 indicates whether the information is raw data or insight information. That is, data that has been processed in some way to reveal insights embedded in the data. For example, the insight “users likely to purchase a car in the next thirty days” is based upon complex processing applied by the offeror to the raw data and the terms reflect this because the offeror is only requiring compensation if the user actually buys a car.

The offer expiration column 425 specifies the conditions under which an offer will expire. For example, an amount of time, such as hours, days, weeks or any other measure of time, may be specified as well as a perpetual offer without any expiration. A date or date range for when the offer will be valid may be specified. Other conditions may be specified.

Other information may be included in the offer listings. For example, in some implementations, statistical information about what the offeror may be willing to offer is associated with an offeror, an offeror's reputation or quality score, past references or testimonials and such type of quality and trust information concerning the offeror and/or the terms. This information may produce matches that are more likely to yield a conversion. For example, a given offeror that works in the product safety field may routinely offer product safety information related to various products. Statistical and/or feedback from others may be utilized to determine whether the offeror is a reliable source for product safety information. If this is the case, the offeror may be flagged as an existing highly reliable source of such information. The offeror may then be matched to a requestor searching for information related to the safety of a specific product. And because the offeror is known as an existing source of such information, the likelihood of a conversion is increased. Requestors can thus also specify the reliability, quality or reputation score as a filter to potential matches for their input requests.

Returning to FIG. 2, the matching engine 215 is adapted to match request listings stored in the request-listing database 225 with offer listings stored in the offer-listing database 230 and to produce a result list that includes one or more of the matched listings. The matching engine 215 may include logic and/or code that operates in conjunction with a processor or other computing device and enables comparing the descriptions of the respective listings to find a match. For example, the number of matching words in respective descriptions may be utilized to determine whether there is a match. The more words in common, the better the match. The matching engine 215 may also be adapted to expand keywords in the respective definitions to find related keywords. This may increase the number of potential matches. Likewise, other known matching techniques may be used including collaborative filtering of actual matches and acceptance of terms through transactions to dynamically modify matching models based on actual usage. Other matching means include social, temporal, spatial and categorical relatedness between an offer and a request.

The result list may be filtered according to the terms specified in the offer listings and the offer made in the request listing. The result list may also be filtered based on other terms, such as the type of requestor with whom an offeror is willing to share information. The matching engine 215 may be adapted to communicate an indication that a match exists to a requestor and offeror(s) with an offer that match(es) the request. The matching engine 215 may also be adapted to communicate a result list of all the matched offers to the requestor and/or an offeror via an interface such as a webpage. Alternatively or in addition, the matching engine 215 may be adapted to communicate the result list via email, SMS, IM, audio or video means.

The transaction manager 217 is adapted to determine whether the various parties associated with a given transaction have agreed with terms associated with the transaction. In some implementations, the transaction manager 217 may implement an interface such as a webpage (not shown) that enables a requestor and/or an offeror associated with a given transaction to specify their acceptance of the terms. For example, the requestor and offeror may select a field on the web page that indicates that they have accepted the terms. Once this occurs, the transaction manager 217 may communicate this fact to the account manager 220.

The account manager 220 is adapted to track and update accounts associated with a requestor and an offeror when transactions are completed. For example, the account manager 220 may deduct a money amount or a credit amount from an account associated with a requester when a requestor receives information from an offeror. The account manager 220 may also deposit a money amount or credit an account associated with the offeror. Deductions and deposits may be performed according to agreed-upon terms. For example, the account manager 220 may be adapted to transfer funds between accounts on a daily, weekly, monthly basis, or a different time period in accordance with terms specified by an offeror.

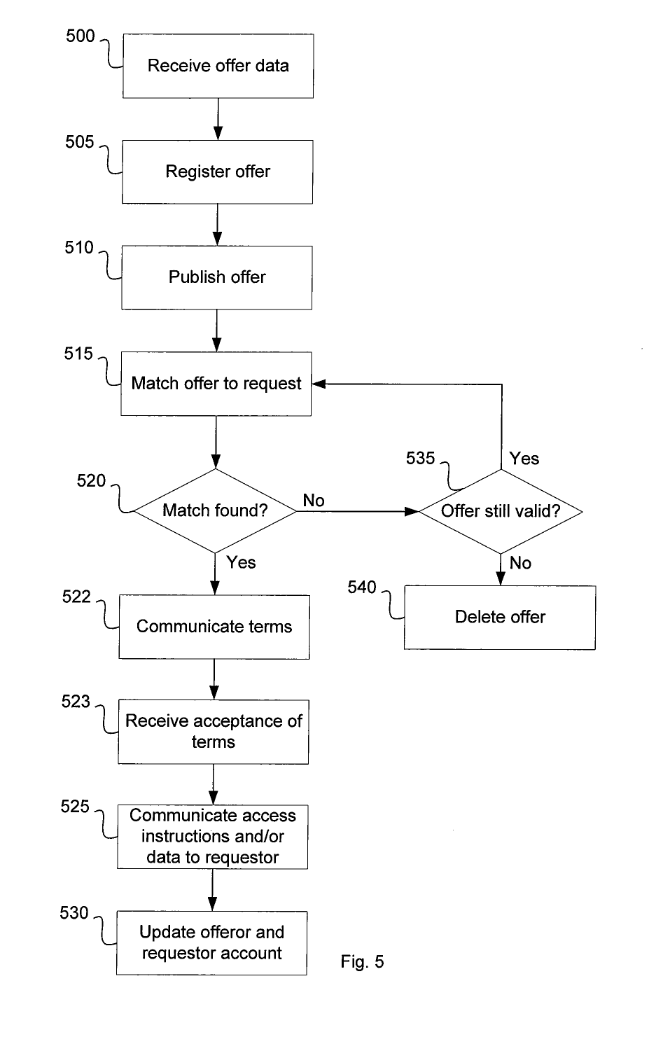

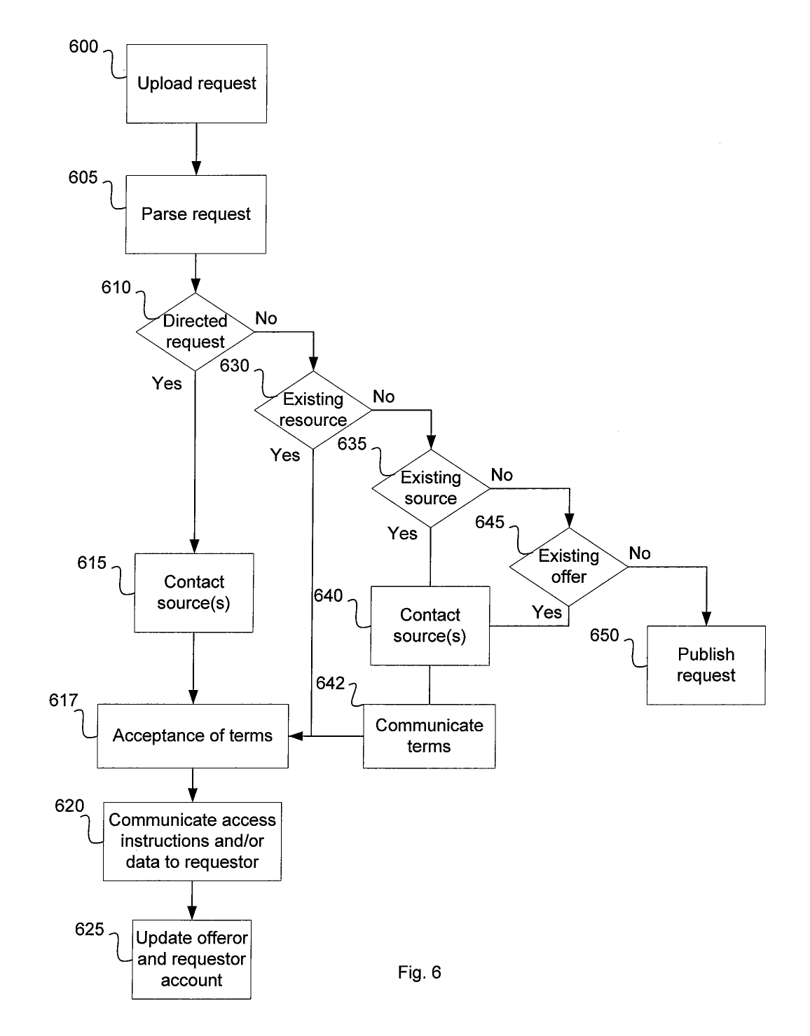

FIG. 5 and FIG. 6 illustrate exemplary operations performed by the exchange system 100. In some implementations, the exchange system may include a computer-readable medium with code operable to cause the request processor 205, offer processor 210, matching engine 215, and account manager 220 shown in FIG. 2 to perform the operations described below. The computer-readable medium may correspond to a memory such as a random-access memory (RAM), read only memory (ROM), flash memory, hard disc drive, a different form of memory, or a combination of these memories.

FIG. 5 illustrates exemplary operations performed by the exchange system 100 (FIG. 1) when an offer is registered with the exchange system.

At block 500, offer data may be received. For example, an offeror may, via an interface such as a webpage interface, communicate an offer to share information. The offer may include a description of the information along with terms for sharing the information. A type for the offer may also be specified. The type may specify whether the source information is raw data or insight information. Data that defines the conditions under which the offer will expire may also be specified. In addition, information that characterizes the offeror may be specified. For example, a user name associated with the offeror. Whether the offeror is an individual, corporation, and/or other form of entity may also be specified.

At block 505, the information received at block 500 may be registered. For example, the information received at block 500 may be stored to a database, such as the offer-listing database 230 (FIG. 1) and/or a different database.

In some implementations, the offer may be validated. For example, information provided by the offeror, such as the offeror's address and bank account information, may be verified. Additionally, a search for any previous offers made by the offeror may be conducted to determine whether the offeror delivered the information offered. Ratings associated with the offeror may be analyzed to determine whether the offeror is trustworthy. Where the offeror's information cannot be verified and/or when the offeror is determined to by untrustworthy, the offeror's offer may not be registered.

At bock 510, the offer may be published. Once published, the offer may be visible to requesters searching for information. The offer may be shown to requestors via an interface such as a webpage interface. The interface may show a portion or all of the information specified by the offeror at block 500.

At block 515, a search for any requests matching the offeror's offer may be performed; and, if a match is found, then at block 520, the requestor and offeror may be notified of the match. For example, key words in a request description may be matched to key words in the offer information description as described above. A score may be applied to the match. For example, the more key words that match, the higher the score. In some implementations, key words in the request description and the offer description may be expanded based on historical information about the relatedness of key words. This may enable matching more requests.

Matching may also include identifying requests listings that match the terms of the offer, and identifying requests from requestors that are of the specified type. For example, matching may include identifying individuals, corporations, non-profit organizations, and/or cooperatives that are compatible with an offer.

If at block 520 one or more matches are found, then at block 522, a message such as an email message may be communicated to an offeror and/or requestor(s) associated with matched request listings indicating that a match has been found. The message may include the terms proposed by the requestors and the offeror. In some implementations, interfaces may be provided that enable the offeror and requestor to view matches. For example, a webpage that shows a result list of all the matching requests may be provided. The result list may be sorted based on various criteria, such as the quality of the match. In some implementations, the result list may be sorted based on a bid amount that a requestor is willing to pay for a particular piece of information. The interface may enable the offeror to watch the bidding process and to select a winning requestor.

At block 523, an acceptance of the terms is received. For example, the requestor(s) and/or offeror may via an interface such as a webpage indicate that they agree to the various terms associated with the request and offer.

At block 525, access instructions for accessing the information may be communicated from the offeror to the requestor. In some implementations, the offeror may directly contact the requestor and provide the requestor with instructions for accessing the information. For example, the offeror may provide an Internet address of a server where the information is stored.

In other implementations, the access instructions may be communicated via the exchange system directly. This may enable the anonymous communication of access instructions. For example, the exchange system may provide a user interface that enables communications between users of the exchange system, where users are identified by non-identifying user information.

At block 530, accounts associated with the requestor and the offeror may be updated according to terms associated with the offer. For example, a monetary amount specified by the terms may be transferred from the requestor's account to the offeror's account. In some implementations, a fee associated with the transaction may be deducted as well. The fee may be deducted from accounts associated with the requestor and/or the offeror.

In some implementations, the offeror and requestor may have negotiated non-monetary terms. For example, the terms may have specified a swap of information or other items between the requestor and the offeror.

In other implementations, the offeror may provide feedback about the requestor associated with the request. For example, a score from one (1) to ten (10) or other scoring system may be utilized to indicate the trustworthiness of the requestor associated with the request listing. The feedback may be associated with the requestor so that future offerors can ascertain whether to share information with the requestor.

Returning to block 520, if a match is not found, then at block 535, if the offer is still valid, the operations may repeat at block 515. For example, the offer may stay valid until the expiration conditions of the offer occur, such as a certain amount of time passes.

If at block 535, the offer is no longer valid, then at block 540, the offer may be removed. For example, information associated with the offer may be removed from the offer database.

FIG. 6 illustrates exemplary operations performed by the exchange system in processing a request. At block 600, a request for information may be communicated to the exchange system. For example, a requestor may, via a webpage interface, communicate a request for information to the exchange system. The request may include a description of the information the requestor is searching for. In some implementations, the requestor may also provide registration information as described above and/or other information.

At block 605, the request description may be processed. For example, a request such as “looking for names of high end car buyers in Chicago” may be processed by a matching engine configured to match based on natural language and/or keywords.

At block 610, if it is determined that the request is to be directed to a specific offeror, then at block 615, the requestor may be put in contact with the offeror. For example, the requestor may specify a user name associated with a specific offeror. The requestor may then contact the offeror via an interface provided by the exchange system. Alternatively, the requestor may contact the offeror through different means, such as via email. The requestor and offeror may then negotiate the terms associated with the sharing of the information. Alternatively, the requestor may have accepted the offeror's terms prior to contacting the offer.

At block 617, an acceptance of the terms is received. For example, the requestor(s) and/or offeror may via an interface such as a webpage indicate that they agree to the various terms associated with the request and offer.

At block 620, if the terms are accepted, access instructions for accessing the information may be communicated from the offeror to the requestor. In some implementations, the offeror may directly communicate the information to the requestor. Alternatively, the offeror may provide instructions for accessing the information. For example, the offeror may provide an address to a server that holds the information and provide the requestor with a temporary user name for accessing the server so that the requestor may download the information.

In some implementations, the access instructions may be communicated via the exchange system. This may enable the anonymous communication of access instructions. For example, the exchange system may provide a user interface that enables communications between users of the exchange system, where users are identified by non-identifying user names.

At block 625, accounts associated with the requestor and/or the offeror may be updated according to the terms associated with the offer. For example, a monetary amount specified in the terms may be transferred from the requestor's account to the offeror's account. In some implementations, a fee associated with the transaction may be deducted as well. The fee may be deducted from the accounts associated with the requestor and/or the offeror.

In some implementations, the offeror and requestor may have negotiated non-monetary terms. For example, the terms may have specified a swap of information or other items between the requestor and the offeror. In some implementations, the exchange system may receive an acknowledgement from the offeror and/or the requestor indicating that the terms have been met.

In some implementations, a rating may be communicated to the exchange system indicating the quality of the information communicated from the offeror. The exchange system may compute an average rating of the various ratings associated with a given offeror. Requestors may see the average rating when searching matched offer listings. Additionally, the requestor and/or offeror may leave feedback about the transaction that may be viewed by others. The ratings and/or feedback may enable requestors and/or offerors to make more informed decisions when deciding whether to transfer information.

If at block 610, the request is not directed to an individual or entity, then at block 430, if it is determined that the information sought may be found at an existing resource, such as an online encyclopedia database, then at block 620, access instructions for retrieving the information from the existing source may be communicated to the requestor.

If at block 630, no resource exists, then if at block 635 it is determined that there is a source or offeror that may be able to obtain the information, then at block 640, that source may be contacted by the exchange system for the information. For example, a requestor searching for product safety information may be matched to an offeror known to be a good source of product safety information.

At block 642, terms associated with the transaction may be communicated to the requestor and/or offeror(s) associated with a match. Then the operations at block 617 may occur as described above.

If at block 635, no known source exists, then at block 645, a search of the offers listings in the offer database may be performed to determine whether any matching offers exist. The matching may be done based on plain language matching, key word matching, and/or a different type of matching. If one or more offer listings match the request description, then the requestor and offeror may be notified of the match at block 640.

If at block 645, a matching offer does not exist, then at block 650, the request description may be published. For example, a request listing associated with the request may be stored to the request-listing database.

FIG. 7 illustrates a general computer system 700, which may represent the request processor 205, offer processor 210, matching engine 215, and/or the account manager 220 of FIG. 1, or any other computing devices referenced herein. The computer system 700 may include a set of instructions 745 that may be executed to cause the computer system 700 to perform any one or more of the methods or computer-based functions disclosed herein. The computer system 700 may operate as a stand-alone device or may be connected, e.g., using a network, to other computer systems or peripheral devices.

In a networked deployment, the computer system may operate in the capacity of a server or as a client-user computer in a server-client user network environment, or as a peer computer system in a peer-to-peer (or distributed) network environment. The computer system 700 may also be implemented as or incorporated into various devices, such as a personal computer or a mobile device, capable of executing a set of instructions 745 (sequential or otherwise) that specify actions to be taken by that machine. Further, each of the systems described may include any collection of sub-systems that individually or jointly execute a set, or multiple sets, of instructions to perform one or more computer functions.

The computer system 700 may include a memory 710 on a bus for communicating information. The request-listing database 225 and offer-listing database may be stored in the memory 710. In addition, code operable to cause the computer system to perform any of the acts or operations described herein may be stored in the memory 710. The memory 710 may be a random-access memory, read-only memory, programmable memory, hard disk drive or any other type of memory or storage device.

The computer system 700 may include a display 730, such as a liquid crystal display (LCD), a cathode ray tube (CRT), or any other display suitable for conveying information. The display 730 may act as an interface for the user to see the functioning of the processor 705, or specifically as an interface with the software stored in the memory 710 or in the drive unit 715.

Additionally, the computer system 700 may include an input device 725, such as a keyboard or mouse, configured to allow a user to interact with any of the components of system 700.

The computer system 700 may also include a disk or optical drive unit 715. The disk drive unit 715 may include a computer-readable medium 740 in which one or more sets of instructions 745, e.g. software, can be embedded. Further, the instructions 745 may perform one or more of the methods or logic as described herein. The instructions 745 may reside completely, or at least partially, within the memory 710 and/or within the processor 705 during execution by the computer system 700. The memory 710 and the processor 705 also may include computer-readable media as discussed above.

The computer system 700 may include a communication interface 735 that enables communications via a network 750. The network 750 may include wired networks, wireless networks, or combinations thereof. The communication interface 735 network may enable communications via any number of communication standards, such as 802.11, 802.17, 802.20, WiMax, cellular telephone standards, or other communication standards.

Accordingly, the method and system may be realized in hardware, software, or a combination of hardware and software. The method and system may be realized in a centralized fashion in at least one computer system or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The method and system may also be embedded in a computer program product, which includes all the features enabling the implementation of the methods described herein and which, when loaded in a computer system, is able to carry out these methods. Computer program in the present context means any expression, in any language, code or notation, of a set of instructions intended to cause a system having an information processing capability to perform a particular function, either directly or after either or both of the following: a) conversion to another language, code or notation; b) reproduction in a different material form.

As shown above, the exchange system enables matching offers for information to requestors searching for the information. The exchange system enables an offeror to specify terms for sharing the information. The exchange system also enables a requestor to specify offer attributes indicating what the requestor is willing to offer for the requested information. Request listings corresponding to request and offer listings corresponding to offers are stored in a request-listing database and an offer-listing database, respectively. The exchange system is configured to match request listings and offer listings based, at least in part, on the description of the information sought and the information for offer. When a match is found, requestors and offerors may be notified of the match. The exchange system may then facilitate the transfer of access instructions for accessing the information. An account management server of the exchange system may the transfer funds from an account associated with the requestor to an account associated with the offeror when the information is transferred. The funds transferred may be related to terms specified by the offeror.

While the method and system has been described with reference to certain embodiments, it will be understood by those skilled in the art that various changes may be made and equivalents may be substituted without departing from the scope. In addition, many modifications may be made to adapt a particular situation or material to the teachings without departing from its scope. Therefore, it is intended that the present method and system not be limited to the particular embodiment disclosed, but that the method and system include all embodiments falling within the scope of the appended claims.

We claim:

1. A method for operating an electronic exchange, the method comprising:
receiving, at an exchange system, an offer that includes a description of information for offer and one or more terms associated with access to the information;
storing, by an offer processor, an offer listing associated with the offer to an offer database;
searching, by a matching engine, a request database for a request listing that matches the offer listing; and
communicating access instructions that enable access to the information to a requestor associated with the request listing when a match is found and the terms are accepted.

2. The method according to claim 1, further comprising exchanging, by an account management processor, an agreed compensation among accounts associated with matched parties when the information is communicated to the requestor.

3. The method according to claim 2, wherein the agreed compensation corresponds to at least one of: cash, credit, points, miles, reputation/quality score, attribution rights, linking rights and access rights.

4. The method according to claim 1, wherein a term defines a type of requestor that is eligible to receive the information.

5. The method according to claim 1, wherein the information corresponds to raw data collected from at least one of: an application, a sensor, an implant, a device, a vehicle, an appliance, a vendor, a data source, and a network.

6. The method according to claim 1, wherein the information corresponds to processed data.

7. The method according to claim 1, further comprising validating the offer.

8. A method for operating an electronic exchange, the method comprising:
receiving, at a request processing transaction manager, a description of requested information;
storing, by the request processing transaction manager, a request listing associated with the requested information to a request database;
searching, by a matching engine, an offer database for an offer listing that matches the request listing;
communicating terms associated with the offer to a requestor associated with the request listing when a match is found; and
communicating access instructions that enable access to the information to a requestor associated with the request listing when a match is found.

9. The method according to claim 8, further comprising exchanging, by an account management processor, an agreed compensation among accounts associated with matched parties when the information is communicated to the requestor.

10. The method according to claim 9, wherein the agreed compensation corresponds to at least one of: cash, credit, points, miles, reputation/quality score, attribution rights, linking rights and access rights.

11. The method according to claim 8, wherein the information corresponds to raw data collected from at least one of: an application, a sensor, an implant, a device, a vehicle, an appliance, a vendor, a data source, and a network.

12. The method according to claim 8, wherein the information corresponds to processed data.

13. An electronic exchange comprising:
an offer processor configured to receive an offer that includes a description of information for offer and terms associated with access to the information, and store an offer listing associated with the offer to an offer database;
a matching engine configured to search a request database for a request listing that matches the offer listing; and
circuitry operable to communicate access instructions that enable access to the information to a requestor associated with the request listing when a match is found and the terms are accepted.

14. The system according to claim 13, further comprising an account management processor operable to exchange an agreed compensation among accounts associated with matched parties when the information is communicated to the requestor.

15. The system according to claim 14, wherein the agreed compensation corresponds to at least one of: cash, credit, points, miles, reputation/quality score, attribution rights, linking rights and access rights.

16. The system according to claim 13, wherein a term defines a type of requestor that is eligible to receive the information.

17. The system according to claim 13, wherein the information corresponds to raw data collected from at least one of: an application, a sensor, an implant, a device, a vehicle, an appliance, a vendor, a data source, and a network.

18. The system according to claim 13, wherein the information corresponds to processed data.

19. The system according to claim 13, further comprising circuitry operable to validate the offer.

20. A machine-readable storage medium having stored thereon a computer program comprising at least one code section for operating an electronic exchange, the at least one code section being executable by a machine for causing the machine to perform acts of:
receiving an offer that includes a description of information for offer and terms associated with access to the information;
storing an offer listing associated with the offer to an offer database;
searching a request database for a request listing that matches the offer listing;
communicating access instructions that enable access to the information to a requestor associated with the request listing when a match is found and the terms are accepted.

21. The machine-readable storage according to claim 20, wherein the code is executable by the machine to cause the machine to exchange an agreed compensation among accounts associated with matched parties when the information is communicated to the requestor.

22. The machine-readable storage according to claim 21, wherein the agreed compensation corresponds to at least one of: cash, credit, points, miles, reputation/quality score, attribution rights, linking rights and access rights.

23. The machine-readable storage according to claim 20, wherein a term defines a type of requestor that is eligible to receive the information.

24. The machine-readable storage according to claim 20, wherein the information corresponds to raw data collected from at least one of: an application, a sensor, an implant, a device, a vehicle, an appliance, a vendor, a data source, and a network.

25. The machine-readable storage according to claim 20, wherein the information corresponds to processed data.
